(19) United States
(12) Patent Application Publication
(10) Pub. No.: US 2013/0028411 A1
(43) Pub. Date: Jan. 31, 2013

(54) Simple Group Security for Machine-to-Machine Networking (SGSM2M)

(71) Applicants: Jari Arkko, Kauniainen (FI); Heidi-Maria Rissanen, Helsinki (FI); Oscar Novo Diaz, Helsinki (FI); Ari Keranen, Kirkkonummi (FI)

(72) Inventors: Jari Arkko, Kauniainen (FI); Heidi-Maria Rissanen, Helsinki (FI); Oscar Novo Diaz, Helsinki (FI); Ari Keranen, Kirkkonummi (FI)

(73) Assignee: Telefonaktiebolaget L M Ericsson (Publ), Stockholm (SE)

(21) Appl. No.: 13/394,514

(22) PCT Filed: Jan. 13, 2012
(86) PCT No.: PCT/EP12/50487

§ 371 Date: Mar. 6, 2012

Related U.S. Application Data
(60) Provisional application No. 61/511,470, filed on Jul. 25, 2011.

(51) Int. Cl. G06F 21/24

(52) U.S. Cl. 380/28

(57) ABSTRACT

A group identity for a set of devices is generated by acquiring an identity for each one of the devices and joining the identities into a common identity data set. A group identity for the set of devices is created by performing a hash function on the common identity set and using a resulting hash value as the group identity. A group identity for a set of devices is verified by acquiring a first group identity from a trusted party. An identity is acquired from each device in the set and the identities are joined into a common identity data set and a second group identity is created for the set of devices by performing a hash function on the common identity data set. A determination is made whether there is a match between the first group identity and the second group identity.

### TECHNICAL FIELD

The invention relates to a method of, and a device for, generating a group identity for a set of devices. The invention further relates to a method of, and a device for, verifying a group identity for a set of devices.

### BACKGROUND

There are several problems associated with the provisioning and management of security parameters for smart object networks, such as e.g. various sensors used in a home environment, for instance temperature sensors:
these small devices have no user interface for configuration that would be required for installation of shared secrets and other security-related parameters. Typically, the devices are not equipped with keyboard, display, or even push-buttons to press. Some devices may only have a single interface, i.e. the interface to the network;
manual configuration is rarely, if at all, possible, as the necessary skills are missing in typical installation environments (such as in family homes);
there may be a large number of devices present in the network. Configuration tasks that may be acceptable when performed for one device may become impracticable with dozens or hundreds of devices.

Existing solutions for security configuration focus on providing security parameters for each device separately, or rely on providing certificates for each device such that their identity can be ensured and/or that they are part of an authorized group. Configuring parameters separately becomes impractical when large amount of nodes are involved, which is a common case in machine-to-machine (M2M) scenarios. Certificates on the other hand provide unnecessary overhead and should be avoided, if possible, in constrained environments. There are existing solutions that employ cryptographically generated identifiers (e.g. cryptographically generated addresses or host identity protocol). Some of these solutions can be used to provide security for individual devices with less provisioning effort. However, there is no mechanism to allow the configuration of a group of nodes in an easy manner, reducing configuration effort from being proportional to the number of devices to the number of groups.

### SUMMARY

An object of the present invention is to solve or at least mitigate these problems in the art and provide a mechanism for easy and straightforward configuration of a group of devices.

This object is achieved in a first aspect of the present invention by a method of generating a group identity for a set of devices where an identity for each one of the devices in the set is acquired, the identities are joined into a common identity data set and a group identity for the set of devices is created by performing a hash function on the common identity data set and using a resulting hash value as the group identity.

This object is achieved in a second aspect of the present invention by a device for generating a group identity for a set of devices. The device comprises a processing unit arranged to acquire an identity for each one of the devices in the set, join the identities into a common identity data set, and create the group identity for the set of devices by performing a hash function on the common identity data set.

This object is achieved in a third aspect of the present invention by a method of verifying group identity for a set of devices, where a first group identity is acquired from a trusted party. Further, an identity is acquired from each device in the set, the identities are joined into a common identity data set and a second group identity is created for the set of devices by performing a hash function on the common identity data set. Thereafter, it is determined whether there is a match between the first group identity and the second group identity.

This object is achieved in a fourth aspect of the present invention by a device for verifying a group identity for a set of devices. The device comprises a processing unit arranged to acquire a first group identity from a trusted party, acquire an identity from each device in the set and join the identities into a common identity data set. The processing unit is further arranged to create the second group identity for the set of devices by performing a hash function on the common identity data set, and determine whether there is a match between the first group identity and the second group identity.

The present invention is advantageous in that identities of the devices contained in a particular set are used to ensure, e.g., using a verifying server, that the set of devices actually is the same set for which a group identifier originally was derived during configuration, in a manner which is easy and efficient to implement and which does not put overly harsh verification demands on the devices. Using a hash function strengthens the integrity of the system, and hash functions are typically fast, one-way and collision-free.

The identities of the devices may e.g. be embodied in the form of public keys, a hash of the respective public key or randomly generated numbers.

In an example, during configuration of the devices by a manufacturer, the individual identities of the devices are concatenated in a certain order, creating a concatenated data set which is input to a (cryptographic) hash function. It should be noted that the identities can be joined together in other ways, for instance by addition. The output of the hash function, also referred to as the digest, is stored for subsequent verification. This is referred to as the first group identity. For instance, the digest can be stored on a server and/or written on a package in which the devices are delivered. In practice, many installations employ a set of devices bought from the same manufacturer and delivered in the same package. When installation personnel is to verify the group identity for the set of devices, he/she can scan each device in the set for its identity, concatenate the identities in the same order as that used during configuration and run the concatenated data through the hash function. The digest produced by the hash function, referred to as the second group identity, is then compared to that created during configuration and stored on the server, and/or written on the packaging—i.e. the first group identity—and if they match, the group identity derived from the devices in the set is considered to be verified. Hence, the devices are considered trustable. Optionally, as a precautionary measure, in case the group identity of the delivered devices is compared to that given on the package in which they were delivered, it may additionally be compared to that stored on the server during device configuration to ensure that the package has not been tampered with to contain any malicious devices.

In a further example, the devices automatically register with the server when they power up, the server concatenates the identities of the devices in the set in the appropriate order, produces a second group identity by taking the hash of the concatenated identities, and then the server displays the resulting second group identity to the installation personnel (which may be the user himself/herself) which compares the second group identity to the first group identity provided by the manufacturer on the packaging.

In yet a further example, the first group identity is scanned from the box by the installation personnel/user and provided to the server. When the devices subsequently are powered up, they send their identities to the server, which concatenates the identities of the devices in the set in the appropriate order, produces a second group identity by taking the hash of the concatenated identities, and then the server compares the acquired first group identity with the created second group identity to see if there is a match, i.e. if the devices in the set can be trusted.

Advantageously, with the present invention, there is no need to configure an identity and a certificate of that identity separately, there is no need to configure a group secret or a shared secret and there is further no need to configure a trust anchor. Moreover, the respective device identity is typically collected anyway by a verifying server for application purposes (such as identifying which sensor is installed in which room); under most circumstances there is thus no additional configuration effort from provisioning security.

In an embodiment of the present invention, the identity of each device is created by joining together the respective public key of each device in the set in a particular order unique for each device in the set and then performing a cryptographic hash function on the public keys that are joined together.

In a further embodiment of the present invention, in case there is hesitation whether a device is trustworthy or malicious, or in case a stricter security approach is desired, non-repudiation could be provided by requesting a device to present a digital signature to the trusted server. This is advantageously implemented by requesting the device to sign its public key with its private key, or alternatively sign the complete message to be sent to the trusted server, and send the signature to the server for verification. To even further strengthen system security, e.g. to prevent off-line attacks, the trusted server provides the device in an embodiment of the invention with a nonce, such as a random number, that the device is requested to sign and return to the server for verification.

As can be deducted from the above, the present invention is highly suitable for machine-to-machine implementation; it does not require any extensive configuration, but still provides strong security and is suitable for typical communication practices of smart object networking environments.

It is noted that the invention relates to all possible combinations of features recited in the claims. Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

The invention is now described, by way of example, with reference to the accompanying drawings, in which:

FIG. 1a illustrates an embodiment of the present invention, showing a basic set-up where a set of devices is registered at a manufacturer during factory configuration;

FIG. 1b shows a flow chart illustrating a method used for registering the devices at the computing device in accordance with an embodiment of the present invention;

FIG. 2a illustrates an embodiment of the present invention, showing a basic set-up where a set of devices is verified during installation of the devices;

FIG. 2b shows a flow chart illustrating a method used for verifying the group identity of the set of the devices at the computing device according to an embodiment of the present invention;

FIG. 3 shows verification of the group identity of the set of devices according to a further embodiment of the present invention;

FIG. 4 shows a flow chart illustrating a method used for verifying the group identity of the set of the devices at the computing device according to a further embodiment of the present invention;

FIG. 5 shows provision of a message timestamp according to an embodiment of the present invention; and

FIG. 6 shows provision of a message sequence number according to an embodiment of the present invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art.

Since the provisioning of security credentials, shared secrets, and policy information can be difficult, the present invention proposes a model based on secure identities. A typical network installation involves physical placement of a number of devices while noting the identities of these devices. This list of short identifiers can then be fed to a central server as a list of authorized devices. Where necessary, the information collected at installation time may also include other parameters relevant to the application, such as the location or purpose of the devices. This would enable the server to know, for instance, that a particular device is the temperature sensor for the kitchen.

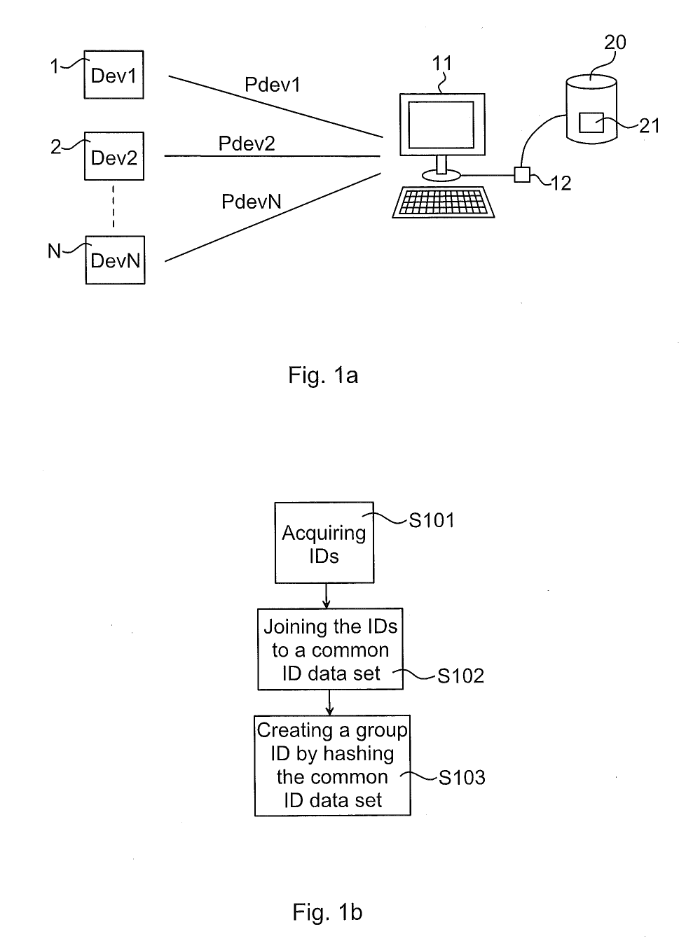

FIG. 1a illustrates an embodiment of the present invention, showing a basic set-up where a set of devices is registered at a manufacturer during factory configuration. The devices 1, N are connected to a computing device 11 which manages the registration. The computing device typically comprises a processing unit 12 in the form of a microprocessor arranged to execute a computer program 21 downloaded to a suitable storage medium 20 associated with the microprocessor, such as a RAM, a Flash memory or a hard disk. The computing device 11 is arranged to at least partly carry out the method according to embodiments of the present invention when the appropriate computer program 21 comprising computer-executable components is downloaded to the memory 20 and executed by the microprocessor 12 of the computing device. The storage medium 20 may be a computer program product comprising the computer program 21. Alternatively, the computer program 21 may be transferred to the storage medium 20 by means of a suitable computer program product, such as a floppy disk or a memory stick. As a further alternative, the computer program 21 may be downloaded to the storage medium 20 over a network. The microprocessor may alternatively be embodied in the form of an application specific integrated circuit (ASIC), a field-programmable gate array (FPGA), a complex programmable logic device (CPLD), etc. It should be noted that the computing device 11 could be embodied by any appropriate device having computing capabilities, such as a mobile phone, a hand-held scanner, a laptop computer, a server, etc.

The connection between the devices to be registered and the computing device 11 is established by means of e.g. a wired network interface, Near-Field Communications (NFC), Radio-Frequency Identification (RFID), Wireless Local Area Network (WLAN), Bluetooth or any technology under the IEEE 802.15.4 standard, such as ZigBee or MiWi. Figure lb shows a flow chart illustrating a method used for registering the devices 1, 2, . . . , N at the computing device 11 in accordance with an embodiment of the present invention. Thus, a group identity is generated for the set of devices 1, 2, N by acquiring an identity for each one of the devices 1, 2, . . . , N in step S101. In an embodiment, the identity of each device 1, 2, . . . , N is represented by its public key Pdev1, Pdev2,, PdevN. Thus, a private-public key pair is generated by each device 1, 2, . . . , N or alternatively, the computing device 11 may generate the private-public key pairs and transfer them securely to the respective device. Thereafter, the identities are joined into a common identity data set in step S102. This could typically be undertaken by concatenating the device identities (Pdev1|Pdev2| . . . |PdevN). Then, in step S103, a group identity is created for the set of devices 1, 2, . . . , N by performing a cryptographic hash function on the common identity data set:

Igrp=h(Pdev1|Pdev2| . . . |PdevN).

Thus, a group identifier Igrp has been created by the computing device 11 for subsequent verification of the devices 1, 2, . . . N.

In an alternative embodiment, the identity of each device 1, 2, . . . N is represented by a (cryptographic) hash of its public key h(Pdev1), h(Pdev2), h(PdevN). The group identity is created in a similar fashion to that just described, resulting in:

Igrp=h(h(Pdev1)|h(Pdev2)| . . . |h(PdevN)).

Thus, an alternative group identifier Igrp has been created by the computing device 11 for subsequent verification of the devices 1, 2, . . . N.

Collecting the identity information at installation time on site (typically at the home of a user) can be arranged in a number of ways. For instance, the last few digits of the identity are printed on the tiny device just a few millimetres across. Alternatively, the packaging for the device may include the full identity (typically 32 hex digits), retrieved from the device at manufacturing time. In this particular case, a hash of the public key is useful, since the hash function advantageously compresses the original public key down to for instance 128 bits. This identity can be read, for instance, by a bar code reader carried by the installation personnel. It should be noted that the identities are not secret; the security of the system is not dependent on whether the identity information is leaked. In an embodiment of the present invention, the real owner of an identity can always prove its ownership with the private key which never leaves the device. This can be undertaken by signing the public key with the private key and providing the signature to a verifier, either as part of the “ordinary” verification process described in the following, or if explicitly requested by the verifier to provide the digital signature. As an alternative, the verifier supplies each device with a nonce, e.g. a random number, which is signed with the respective private key of each device, wherein the resulting signatures are sent to the verifier for subsequent verification. In yet an alternative, the complete message send to the trusted server is signed with the private key of the device and the signature is provided to the server for subsequent verification. As mentioned, the device may use its wired network interface or proximity-based communications, such as NFC or Radio-Frequency Identification RFIDs. Such interfaces allow secure communication of the device identity to a verifying device at installation time. No matter what the method of information collection is, this provisioning model reduces the effort required to set up a secure system. Each device generates its own identity in a random, secure key generation process. The identities are self-securing in the sense that if you know the identity of a party you want to communicate with, messages from the party can be signed by the private key of the party and it is trivial to verify that the message came from the expected party. Thus, in an embodiment of the present invention, each device in the set is provided with the public key of each remaining device in the set.

Advantageously, in case there is a need for a device to be able to verify the identity of another particular device in the set, it can simply do so by using the public key of the particular device to verify a digital signature provided by the particular device,

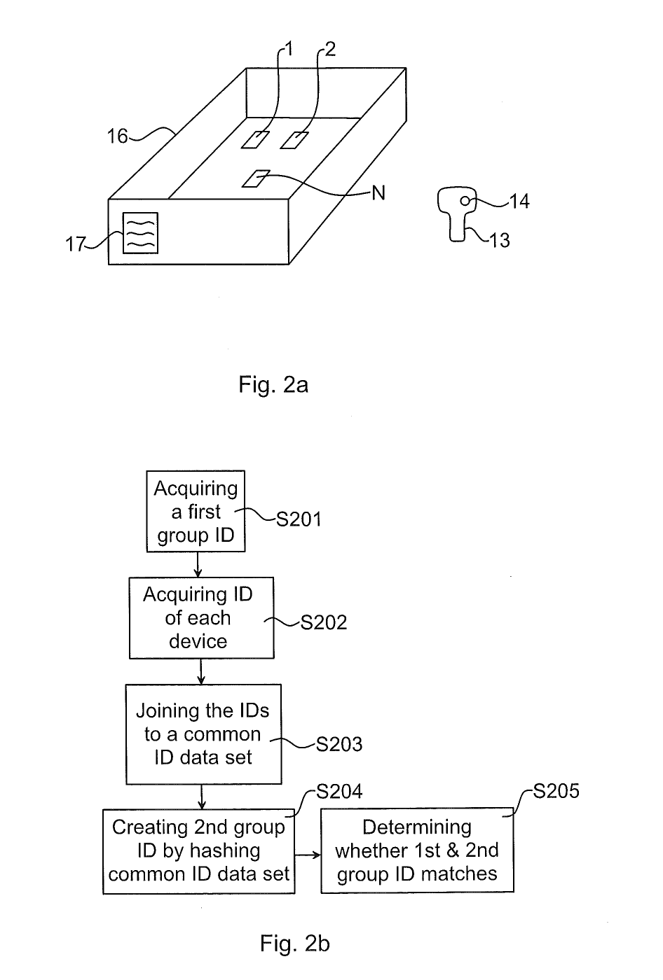

FIG. 2a illustrates an embodiment of the present invention, showing a basic set-up where a set of devices is verified during installation of the devices, typically in the home of a user. The set of devices 1, 2, . . . , N is delivered in a packaging 16 on which the group identity 17 created during configuration (described in connection to FIG. 1) is printed. Installation personnel have access to a scanning device 13 comprising a processing unit 14 similar to that discussed with reference to FIG. 1. Now, the group identity 17 printed on the packaging is provided by a trusted party, i.e. the manufacturer or possible an authorized distributor, and will be used to verify whether the devices 1, 2, . . . , N located therein can be considered trustworthy.

Further reference is made to FIG. 2b, which shows a flow chart illustrating a method used for verifying the group identity of the set of the devices 1, 2, . . . , N at the computing device according to an embodiment of the present invention. Thus, a first group identity 17 is acquired from the packaging 16 in step S201 by having the installation personnel move the scanning device 13 over a label on which the first group identity is printed. Further, in step S202, an identity Pdev from each device in the set is acquired in the same manner. The processing unit 14 in the scanning device 13 joins the identities into a common identity data set in step S203, typically by concatenating the identities, thereby creating (Pdev1|Pdev2| . . . |PdevN). Then, in step S204, a second group identity is created for the set of devices1, 2, . . . N by having the processing unit 14 perform a hash function on the common identity data set:

Igrp=h(Pdev1|Pdev2| . . . |PdevN).

Finally, in step S205, the second group identity is compared to the first group identity 17 scanned from the packaging and if there is a match, the second group identity created from the scanned device identities is considered verified. Hence, the devices 1, 2, . . . , N are considered trustable.

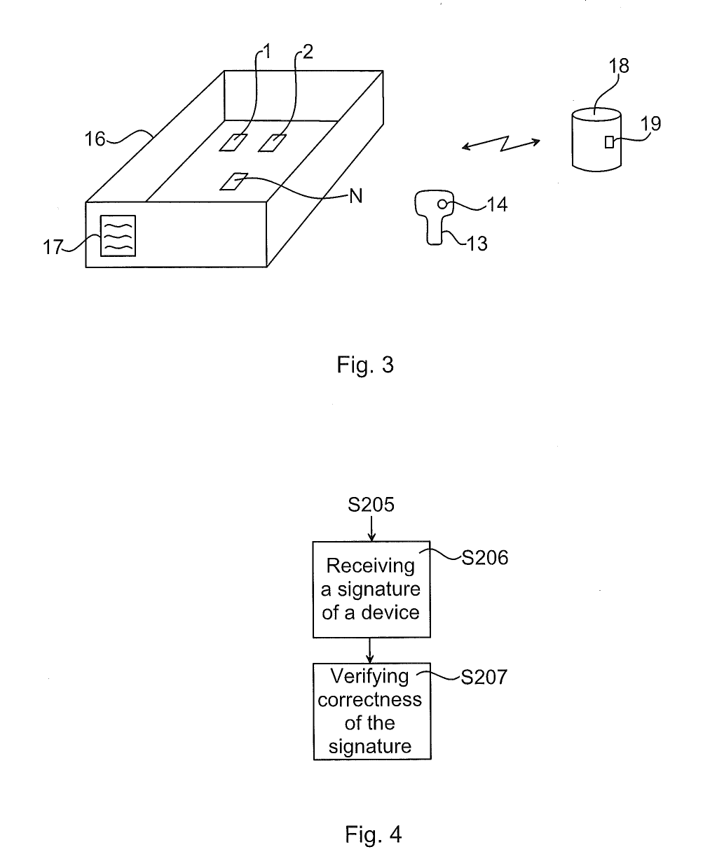

In a further embodiment of the present invention, with reference to FIG. 3, the devices 1, 2, . . . , N automatically undertake a wireless registration with a remotely located server 18 when they power up, the server 18 comprises a processing unit 19 which concatenates the identities of the devices in the set in the appropriate order, as previously has been described, produces a second group identity by taking the hash of the concatenated identities, and then the server 18 communicates the resulting second group identity to the scanning device 13 of the installation personnel (which may be the user himself/herself) which compares the second group identity to the first group identity 17 provided by the manufacturer on the packaging 16.

In yet a further embodiment of the present invention, also with reference to FIG. 3, the first group identity 17 is scanned from the box 16 by the installation personnel/user and provided to the server 18 via wireless communication. When the devices 1, 2, . . . N subsequently are powered up, they send their identities to the server 18, which concatenates the identities of the devices 1, 2, . . . , N in the set in the appropriate order, produces a second group identity by taking the hash of the concatenated identities, and compares the acquired first group identity 17 with the created second group identity to see if there is a match, i.e. if the devices 1, 2, . . . , N in the set can be trusted.

FIG. 4 shows a flowchart continuing from that discussed with reference to FIG. 2b, which illustrates an embodiment where a device sends in step S206, either on its own responsibility or at request of e.g. the previously discussed server 18, a signed copy of its public key (i.e. a digital signature is provided), wherein the server in step S207 can verify correctness of the digital signature by means of the corresponding public key of the device. As previously mentioned, as an alternative, the server 18 supplies each device with a nonce, such as a random number, wherein the respective random number is signed with the private key of each device and the resulting signatures are sent to the server for verification. In yet an alternative, the complete message send to the server is signed with the private key of the device.

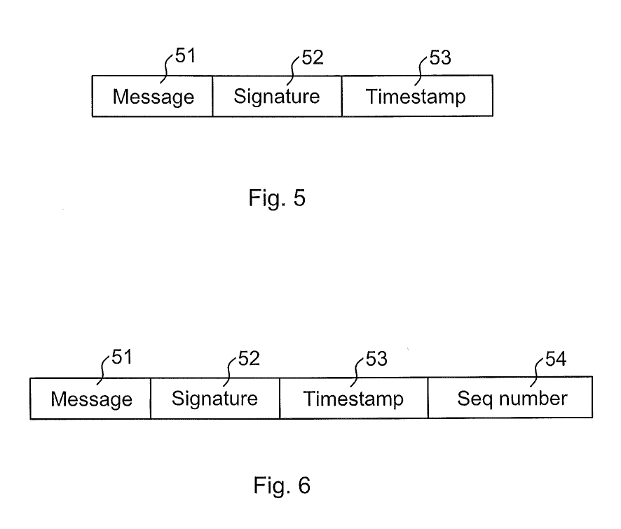

In a further embodiment of the present invention, with reference to FIG. 5, to further improve security, for instance to be able to withstand denial-of-service and replay attacks, the digital signature 52 will be supplemented with a timestamp 53. Connectivity in smart object networks can be expected to be intermittent, and traditional active methods such as nonce exchanges may not always be suitable. Instead, a timestamp-based approach can be used in addition to the digital signatures. Devices that implement the timestamp approach need to have a real-time clock or alternatively need to synchronize to one using a network time protocol. Thus, the digital signature 52 from a device is further accompanied by a timestamp 53, and if the value of the timestamp 53 deviates from actual time of reception by more than a predetermined threshold value a message 51 associated with the digital signature 52 should be ignored. As can be seen in

FIG. 5, a message 51 is sent, for instance comprising the device identifier required to create a group identity. The digital signature 52 is verified at the recipient by means of the public key of the device. It should be noted that already at this stage, if the signature 52 cannot be verified, the accompanying message will be ignored. However, if the digitally signed message is verified, the timestamp 53 will be checked, and if the value of the timestamp 53 deviates from the current time, i.e. the time of reception of the message, by more than a predetermined value, the message will be ignored.

In yet a further embodiment of the present invention, a message 51 illustrated in FIG. 6 is further accompanied by a sequence number 54 which preferably is strictly monotonically increasing in relation to previously issued sequence numbers for messages from this particular sender. Thus, a first message will have sequence number “1”, a second message issued after the first message will have sequence number “2”, a third message issued after the second message will have sequence number “3”, and so on. If a message is received which does not have a higher sequence number 54 than a previously received message from this particular sender, the message 51 is ignored. This embodiment advantageously further strengthens security. It should be noted that the message 51 not necessarily is accompanied with a timestamp 53 in this particular embodiment.

In still another embodiment of the present invention, the identity of each device is created by joining together the respective public key of the each device in the set in a particular order unique for each device in the set and then performing a cryptographic hash function on the public keys that are joined together.

Thus, the public key Pdev of each device in the set is concatenated such that a unique sequence is formed for each device. Thereafter, a cryptographic hash function is performed on the unique sequence for each device. This could result in the following unique identities:

Idev1=h(Pdev1|Pdev2|Pdev3| . . . |PdevN);

Idev2=h(Pdev2|Pdev1|Pdev3| . . . |PdevN);

Idev3=h(Pdev3|Pdev1|Pdev2| . . . |PdevN);

IdevN=h(PdevN|Pdev1|Pdev2| . . . |PdevN−1).

Hence, in this particular example, the unique sequence is created by placing the public key of the device for which the identity is to be created first in the sequence of public keys and then having the remaining keys follow in numerical order. However, any appropriate order can be used as long as the sequence is unique for each device in the set. As previously has been mentioned, it would alternatively be possible to concatenate the cryptographic hash of the public key of each device.

The reason for having every public key of the device set as part of the final device identity is to bind all the identities together in order to prevent an attacker from adding new devices, removing devices, or changing public keys, as such operations would invalidate all the identities, and hence the attack would be easily detected.

The communication brought about by the present invention is typically implemented at the application layer. More specifically, in the data formats transported in the payload part of the constrained application protocol (COAP). This approach provides the following benefits:
ability for intermediaries to act as caches to support different sleep schedules, without the security model being impacted,
ability for intermediaries to be built to perform aggregation, filtering, storage and other actions, again without impacting the security of the data being transmitted or stored,
ability to operate in the presence of traditional middleboxes, such as a protocol translators or even network address translators (NATs). Note that there is no requirement that the secure identities are associated with IP addresses, even though they can be used as input material for constructing addresses for stateless address auto configuration.

The above architecture is a highly suitable for sensor networks where information flows from a large number of devices to a small number of servers (possibly only a single server). However, for other types of applications such as e.g. actuator applications, a large number of devices need to receive commands from one or more sources. In such applications, it may be necessary to verify that the commands originate from an authorized source. Thus, in an embodiment of the present invention, the devices are informed of the identity of the (trusted) party with which they subsequently are to verify their group identity (e.g. server 18). This can be effected during factory configuration or at device installation, which may require either a separate user interface, local connection (such as USB), or using a network interface of the device. Thus, a device will accept a message from the source in case the source can present a trusted identity. Advantageously, the amount of configuration information is held at a minimum: only single trusted source identity needs to be stored at the respective device; there are no shared secrets that must be kept confidential. When both peers have received the expected identity of the other peer off-line, secure communication can commence.

Alternatively, various pairing schemes can be employed. Note that these schemes can benefit from the already secure identifiers on the device side. In a further embodiment, the party which is to verify the group identity of the devices, e.g. the server 18, can send a pairing message comprising the server identity to each device after their initial power-on and before they have been paired with anyone else, encrypted with the public key of the respective device.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of generating a group identity for a set of devices, the method comprising:
acquiring an identity for each one of the devices in the set;
joining the identities into a common identity data set;
creating the group identity for the set of devices by performing a hash function on the common identity data set.

2. The method of claim 1, wherein joining the identities into a common identity data set comprises:
concatenating the identities of the set of devices.

3. The method of claim 1, wherein the identity of each device is a public key of the device.

4. The method of any claim 1, wherein the respective identity of each one of the devices is a hash of the public key of the device.

5. The method of claim 3, wherein the respective identity of each one of the devices is created by joining together the respective public key of each one of the devices in the set in a unique order for each one of the devices and performing a hash function on the public keys that are joined together for each one of the devices.

6. The method of claim 1, further comprising:
generating a private-public key pair for each one of the devices in the set.

7. The method of claim 3, further comprising:
providing each one of the devices in the set with the respective public key of each remaining one of the devices in the set.

8. The method of claim 1, further comprising:
providing each one of the devices in the set with an identity of a party creating the group identity.

9. The method of claim 8, further comprising:
encrypting the identity of the party with the respective public key of the one of the devices to which the encrypted identity is to be sent.

10. A device for generating a group identity for a set of devices, the device comprising a processing unit being configured to:
acquire an identity for each one of the devices in the set;
join the identities into a common identity data set;
create the group identity for the set of devices by performing a hash function on the common identity data set.

11. A method of verifying a group identity for a set of devices, comprising:
acquiring, from a trusted party, a first group identity;
acquiring an identity from each one of the devices in the set;
joining the identities into a common identity data set;
creating a second group identity for the set of devices by performing a hash function on the common identity data set; and
determining whether there is a match between the first group identity and the second group identity.

12. The method of claim 11, further comprising:
receiving a digital signature from at least one one of the devices; and
verifying correctness of the digital signature by means of a corresponding public key.

13. The method of claim 12, wherein receiving the digital signature from at least one of the devices further comprises receiving a timestamp associated with the digital signature, the method further comprising:
ignoring a message accompanying the digital signature if the value of the timestamp deviates from actual time of reception of the message by more than a threshold value.

14. The method of claim 12, wherein receiving the digital signature from at least one of the devices further comprises receiving a monotonically increasing sequence number associated with the digital signature, the method further comprising:
ignoring a message accompanying the digital signature if the sequence number of the message is not greater than a sequence number accompanying a previously received message.

15. The method of claim 11, wherein the first group identity is acquired from a packaging in which the set of devices is delivered.

16. A device for verifying a group identity for a set of devices, the device comprising a processing unit being configured to:
acquire, from a trusted party, a first group identity;
acquire an identity from each one of the devices in the set;
join the identities into a common identity data set;
create a second group identity for the set of devices by performing a hash function on the common identity data set; and
determine whether there is a match between the first group identity and the second group identity.

17. The device of claim 16, said device being a hand-held device configured to acquire the first group identity and the respective identities from each of the devices in the set by means of scanning.

18. The device of claim 16, said device being a remotely located device configured to acquire the first group identity and the respective identities from each of the devices via a communication interface.

19. The device of claim 18, said device being configured to acquire the first group identity via communication with a scanning device operable to read the first group identity, and to acquire the respective identities from each of the devices by means of communication with each one of the devices in the set.

20. A system comprising:
a processor; and
a memory having a computer program stored thereon, the computer program being configured to carry out the method of claim 11.

21. A computer program product comprising:
a computer readable medium, the computer readable medium having a computer program embodied therein, the computer program being configured to carry out the method of claim 11.
